(19) United States
(12) Patent Application Publication
(10) Pub. No.: US 2014/0287979 A1
(43) Pub. Date: Sep. 25, 2014

(54) Bamboo Snow as Cleaning Agent

(71) Applicant: James Alexander Hinds, Saipan, MP (US)

(72) Inventor: James Alexander Hinds, Saipan, MP (US)

(21) Appl. No.: 14/304,934

(22) Filed: Jun. 15, 2014

(51) Int. Cl. C11D 7/44

(52) U.S. Cl. CPC C11D 7/44
USPC 510/462; 134/7

(57) ABSTRACT

Bamboo Snow as described here is a naturally occurring, useful, unique and beneficial organo-silicate substance. Bamboo Snow is the powder resulting from combined insect and microbial action on hollow reeds and bamboo. It has unique absorbant and adsorbent properties in addition to many of the properties of inorganic silicates. When used in composition, It has the advantage of enhancing the effect of any compatible cleaning agent.

### BACKGROUND

1. Field of Invention

Man has used mixtures of natural substances for cleaning purposes since before recorded history.

Bamboo Snow is a substance newly documented in U.S. Patent application 14304932 which details its characteristics and provides a method for producing bamboo snow in any commercial quantity.

The characteristics of bamboo snow as an aid to cleaning are several:

It is as well tolerated by humans as bamboo itself, and is generally regarded as safe.

When used by itself, as a powder, it has the ability to clean hands, removing grease, oil, food or other material without water. Simply rubbing the hands and fingers with bamboo snow will break up and absorb these materials. The waste forms small clumps that drop or are shaken off. Any residue of bamboo snow can be ignored or is easily rinsed away.

Bamboo snow has a high silicon content which acts as a micro-abrasive. It leaves no visible scratches.

Bamboo snow degrades easily in nature and returns to the soil as organic matter and silt.

Bamboo snow will absorb oils from spills.

Bamboo snow will absorb up to three times its weight in oil, grease or other hydrophobic substance and will form easy to handle clumps.

Bamboo snow will absorb up to two times its weight in water or wet hydrophilic substance and will form easy to handle clumps.

Bamboo snow will absorb up to five times its weight with a combination of wet or oily substances and form easy to handle clumps.

Adding additional water creates a free flowing suspension that rinses away easily.

When used in a composition with any chemically non-reactive cleaning agent, bamboo snow acts like a sponge. This sponge action releases the cleaning agent upon the object, and releasing the pressure re-absorbs the surface contaminates. Bamboo snow aids in the delivery of the cleaning agent, and provides micro-abrasive action to dislodge surface contaminants.

2. Discussion of Prior Art

Bamboo Snow is a substance that has been mislabeled as frass, and therefore equivalent to refuse. However as disclosed in U.S. Patent Application 14304932, there has been no prior art regarding bamboo snow prior to my own investigations, starting Jun. 25, 2013.

The art of cleaning is based on cleaning up dirt. Therefore, bamboo snow has been considered something to discard, and not use as a cleaning agent.

### OBJECTS AND ADVANTAGES

The bamboo available on Saipan provides a Bamboo Snow which is mesoporous and can absorb up to three times its weight in oil. Bamboo or reed stock from other locations would provide similiar, if not exact capabilities. The term Bamboo Snow is explicitly used to refer to a substance produced as described in US Patent Application 14304932, rather than the exact specie of insect, microbe or plant.

Bamboo snow, when used alone, without water, absorbs oil and dirt from surfaces, hands, skin or hair. This is the very definition of a waterless cleaner, but such information has never been noted in any literature.

Bamboo Snow, when compounded with compatible solvents, will hold and apply the solvent on surfaces, skin or hair. Bamboo snow's sponge-like quality magnifies the effect of the solvent by spreading the solvent on the specific areas needing cleaning. Pressing on the compound on the surface releases the solvent, while releasing pressure on the compound re-absorbs the solvent and any newly dissolved surface contaminants. Bamboo snow also provides a micro-abrasive action which helps release surface contaminants.

Bamboo Snow, when compounded with compatible conditioning agents, will hold and apply those agents to any object, surface, skin or hair.

Bamboo Snow rinses easily. This added ability of easy rinsing is extended to any compound of bamboo snow.

1. A method of removing contaminants from a surface by rubbing Bamboo Snow onto the surface thereby absorbing the contaminants into the bamboo snow which is then easily removed.

2. A composition of Bamboo snow and any chemically compatible solvent in sufficient quantity results in a cleaning agent with superior cleaning and rinsing properties.

3. A composition of Bamboo snow and chemically compatible materials both solvent and non-solvent results in a compound that is able to simultaneously remove contaminants while depositing conditioning agents to the surface.
